(19) United States
(12) Patent Application Publication
(10) Pub. No.: US 2026/0179276 A1
(43) Pub. Date: Jun. 25, 2026

(54) LANGUAGE MODEL METHOD FOR DYNAMIC WORKFLOW AUTOMATION

(71) Applicant: Intuit Inc., Mountain View, CA (US)

(72) Inventors: Isabella Leigh SCHEIER, Sebastopol, CA (US); Mark MAYNARD, Tucker, GA (US); Maura Marie LYNCH, Brooklyn, NY (US); Amit AGRAWAL, Mountain View, CA (US); Ashton Phillips GRIFFIN, Steamboat Springs, CO (US)

(73) Assignee: Intuit Inc., Mountain View, CA (US)

(21) Appl. No.: 18/987,750

(22) Filed: Dec. 19, 2024

(51) Int. Cl. G06T 11/60; G06F 40/186

(52) U.S. Cl. CPC G06T 11/60; G06F 40/186

(57) ABSTRACT

A method including advancing a computer-automated workflow a step. The method also includes retrieving an image template including a computer renderable data structure for rendering an image. The image template is specific to the step. The method also includes retrieving a prompt template including a prompt data structure for input to a language model. The prompt template is specific to the step. The method also includes combining the image template and the prompt template to generate a combined prompt. The method also includes executing a language model with the combined prompt to generate an output of the language model. The method also includes rendering the output to generate a rendered data structure.

### BACKGROUND

Most computer users of are not technically sophisticated in the underlying software or hardware technology that enable computers to function. In the case of software, the functionality of certain software applications may be difficult to master, due to complex user interfaces or the complex commands users of such technology learn in order to take advantage of such software applications.

In one example, a software application may generate an automated workflow for a user to follow. The workflow guides a user to select parameters for, or to engage in, certain computer-related tasks to accomplish a larger task. As a specific example, the workflow steps are related to coding a software utility application. As another example, the user works through a larger workflow, where each step in the larger workflow includes multiple sub-steps. In any case, each of the workflow steps involve complex user interfaces and the use of complex commands, either of which may daunt some users.

Therefore, a technical problem is presented. The technical problem is how to program a computer to automatically suggest solutions for complex workflows when the complex workflows are designed to rely on user input to be completed.

### SUMMARY

One or more embodiments provide for a method. The method includes advancing a computer-automated workflow a step. The method also includes retrieving an image template including a computer renderable data structure for rendering an image. The image template is specific to the step. The method also includes retrieving a prompt template including a prompt data structure for input to a language model. The prompt template is specific to the step. The method also includes combining the image template and the prompt template to generate a combined prompt. The method also includes executing a language model with the combined prompt to generate an output of the language model. The method also includes rendering the output to generate a rendered data structure.

One or more embodiments also provide for a system. The system includes a computer processor and a data repository in communication with the computer processor. The data repository stores a computer-automated workflow including a number of steps including a step. The data repository also stores an image template including a computer renderable data structure for rendering an image. The image template is specific to the step. The data repository also stores a prompt template including a prompt data structure for input to a language model. The prompt template is specific to the step. The data repository also stores a combined prompt. The data repository also stores an output of the language model. The data repository also stores a rendered data structure. The system also includes the language model executable by the compute processor with the combined prompt to generate the output. The system also includes a server controller which, when executed by the processor, performs a computer-implemented method. The computer-implemented method also includes advancing the computer-automated workflow by the step. The computer-implemented method also includes retrieving the image template and the prompt template. The computer-implemented method also includes combining the image template and the prompt template. The computer-implemented method also includes executing the language model to generate the output. The computer-implemented method also includes render the output to generate the rendered data structure.

One or more embodiments provide for another method. The method includes advancing a computer-automated workflow a step. The method also includes retrieving an image template including a computer renderable data structure for rendering an image. The image template is specific to the step. The method also includes retrieving a prompt template including a prompt data structure for input to a language model. The prompt template is specific to the step. The method also includes combining the image template and the prompt template to generate a combined prompt. The method also includes executing a language model with the combined prompt to generate an output of the language model. The method also includes rendering the output to generate a rendered data structure. The method also includes displaying, on a display device, the rendered data structure. The method also includes retrieving an additional image template specific to the step. The method also includes combining the additional image template with the prompt template to generate an alternative prompt. The method also includes executing the language model with the alternative prompt to generate an alternative output of the language model. The method also includes rendering the alternative output to generate an alternative rendered data structure. The method also includes displaying, on a display device together with the rendered data structure, the alternative rendered data structure. The method also includes receiving a user selection of one of the rendered data structure and the alternative rendered data structure. The method also includes generating an electronic message using the user selection. The method also includes transmitting the electronic message over a computer network.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a language model method for dynamic workflow automation, in accordance with one or more embodiments.

FIG. 3 shows a data flow for a language model method for dynamic workflow automation, in accordance with one or more embodiments.

FIG. 4A, FIG. 4B, and FIG. 4C show an example of a language model method for dynamic workflow automation, in accordance with one or more embodiments.

FIG. 5A and FIG. 5B show a computing system and network environment, in accordance with one or more embodiments.

Like elements in the various figures are denoted by like reference numerals for consistency.

### DETAILED DESCRIPTION

One or more embodiments are directed to programing a computer to automatically suggest solutions for complex workflows when the complex workflows are designed to rely on user input to be completed. Thus, one or more embodiments are directed towards a technical solution to the technical problem described above.

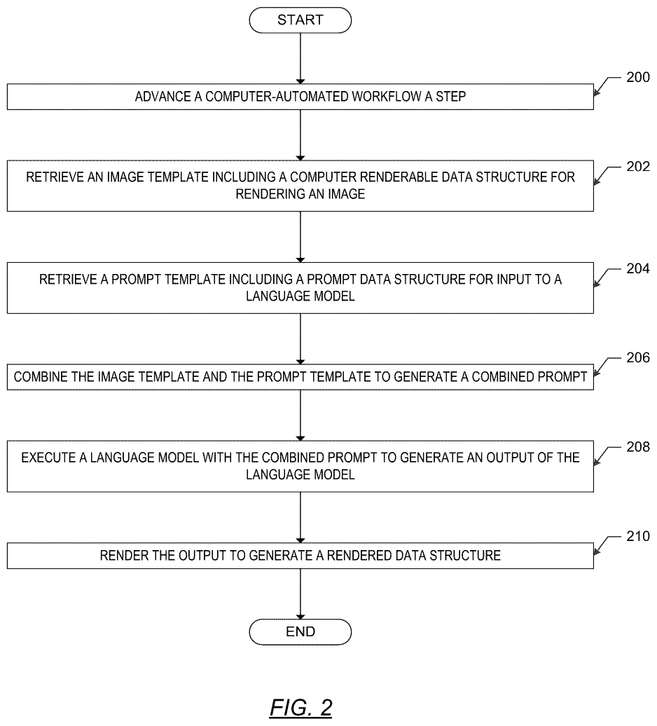

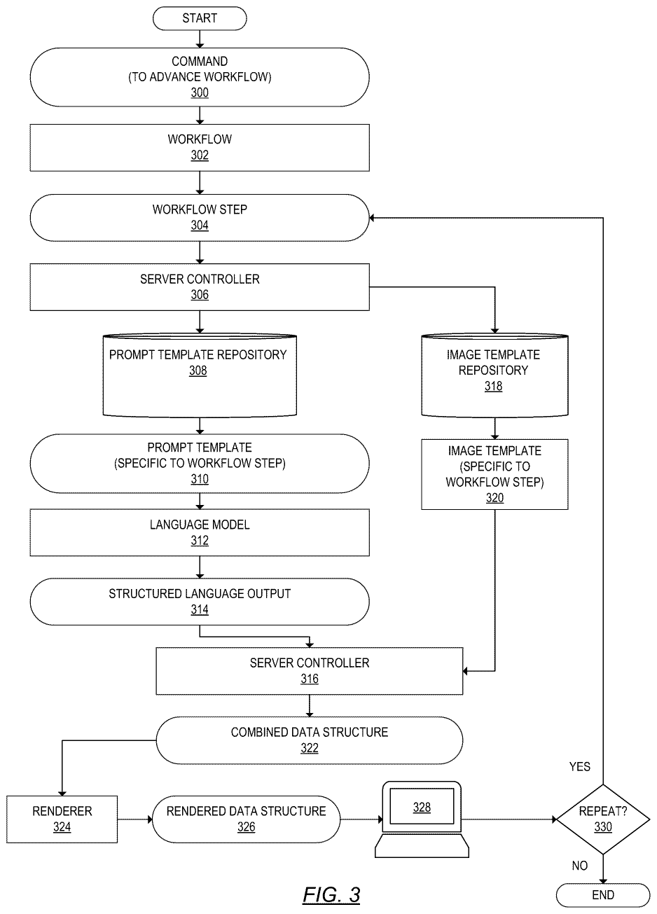

The technical solution is described, in detail, with respect to the figures. In brief, the workflow is advanced to a step within the workflow. Then, the technical solution involves applying a language model and templates to automatically complete the tasks involved with the workflow step. More specifically, one or more embodiments retrieve a prompt template and possibly an image template, or other type of template, from one or more data repositories. The template or templates are specifically designed for use with respect to the current workflow step. A server controller (a program configured to execute a workflow, such as shown in FIG. 2 or FIG. 3) then generates a prompt by combining the prompt template with information about the user or other types of information pertinent to the workflow step.

A language model then executes with the prompt. The output of the language model is a structured language data structure. The structured language data structure contains computer-readable instructions for presenting information (e.g., text, numbers, the structure of a message, etc.)

If other templates are generated with respect to the workflow step, then the server controller combines the structured language data structure with the template or templates. For example, if an image template is retrieved for the workflow step, then the server controller combines the structured language data structure with the image template to generate a combined data structure.

The combined data structure is provided to a renderer. A renderer is software or application specific hardware that, when executed, generates a rendered data structure. The rendered data structure is available for additional processing. For example, the rendered data structure may be rendered on a display device. However, the rendered data structure may be provided to another program to perform some other desired computer function.

Rendering the rendered data structure may, in some cases, complete the workflow step at issue. However, additional sub-steps may be involved. For example, the user may approve or disapprove of a rendered image that was generated using the rendered data structure. When the user approves of the rendered image or selects from among multiple rendered images generated using the procedure described above, then the workflow step may be considered completed.

Once the workflow step is completed, the workflow advances another step. The process described above may repeat to assist the user to complete the new workflow step. The process may continue to repeat until the workflow reaches a conclusion. Thus, one or more embodiments provide a technical solution in that a computer is automatically programmed to complete, or largely complete, complex tasks involved in a workflow by applying a language model and templates at each step to generate rendered data structures. The rendered data structures may be used in the completion of the workflow steps or for other computer functions.

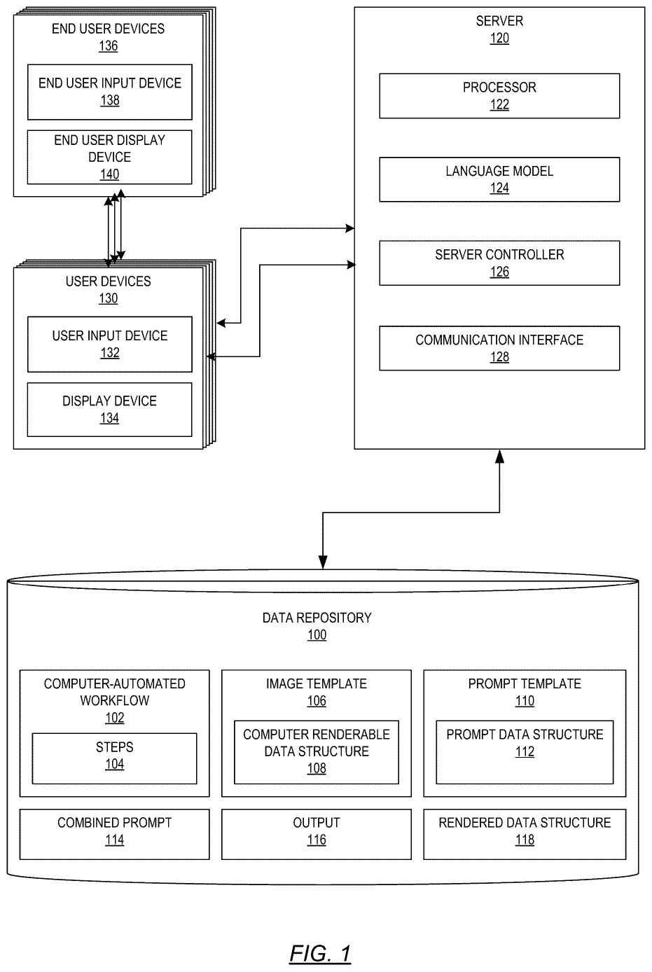

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores a computer-automated workflow (102). The computer-automated workflow (102) is a computer-executable program that performs one or more steps (104) in a computer-executed process. User input may be solicited at one or more of the steps (104) of the computer-automated workflow (102). The steps (104) are defined more formally below.

In an embodiment, the computer-automated workflow (102) may be implemented as a master template. The master template contains a series of computer-implementable steps (i.e., the steps (104)). In use, a server controller identifies the step with which a user is working. The step-specific templates and prompts, described below, may be drawn from or referenced by the master template. Each step involves a specific computer-implemented process (e.g., design and send an email, or short message service (SMS), etc.)

In another embodiment, the computer-automated workflow (102) may be a number of blocks of a message template for an electronic message. In other words, a template (e.g., the image template (106) or the prompt template (110) defined below) may include the computer-automated workflow (102). In this case, the step may be one of the blocks.

As used herein, the “user” is the user device that interacts with the computer-automated workflow (102). However, one or more embodiments may refer to an “end user.” The “end user” is a computing device with whom the user interacts (e.g., a third-party computing device, such as the end user devices (136) described below).

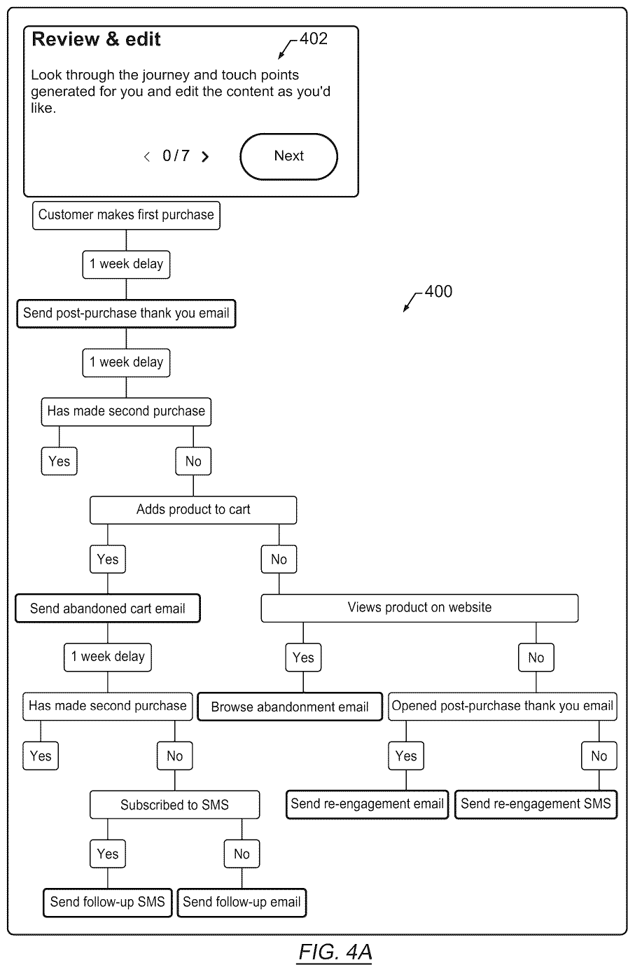

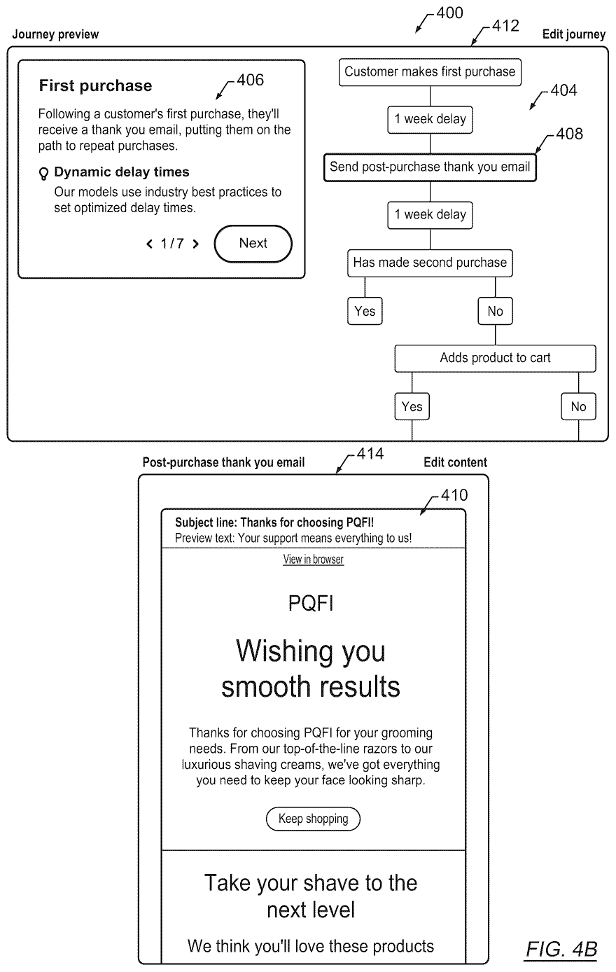

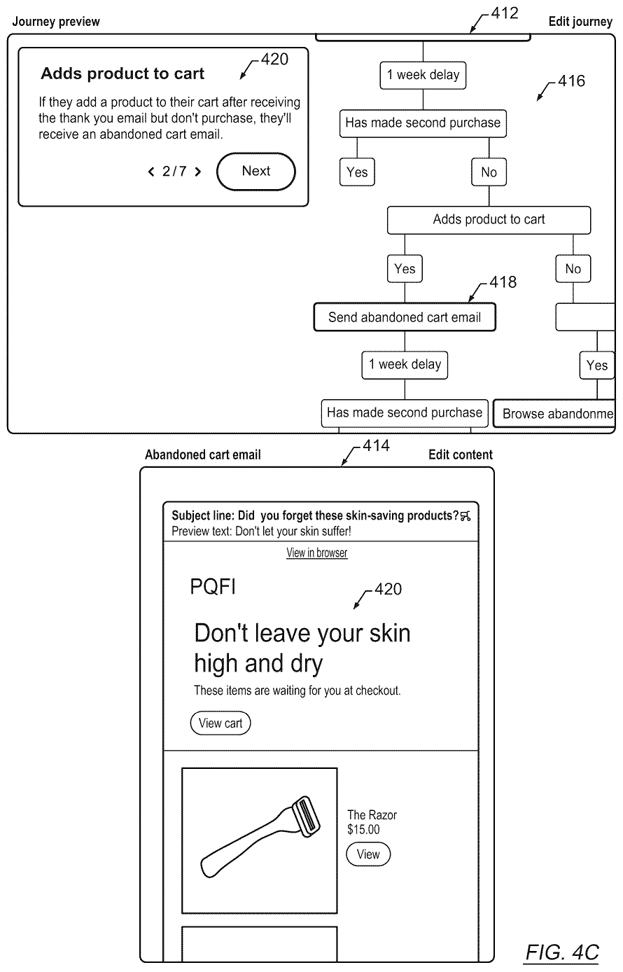

An example of the computer-automated workflow (102) is shown in FIG. 4A. As described in more detail with respect to FIG. 4A, the computer-automated workflow (102) may be a process in which the user is guided through a series of steps which, taken together, implement a sequence of electronic interactions with an end user.

In any case, at each of the one or more steps in which user input is solicited, the user performs complex manipulations of the graphical user interface (GUI) widgets of the computer-automated workflow (102), or complex manipulations of one or more stored computer files at the one or more steps. A complex manipulation is a manipulation for which an untrained user, or inadequately trained user, experiences difficulty or frustration in performing the manipulation, or the untrained user is unable to perform the manipulation. As described herein, the computer-automated workflow (102) includes at least one step which includes a complex manipulation, and thus will benefit from the technical solution described with respect to FIG. 2 and FIG. 3.

As indicated above, the computer-automated workflow (102) includes one or more steps (104). The steps (104) are computer-implemented algorithms. At least some of the steps (104) solicit user input. At least one of the steps (104) includes a complex manipulation for the user to provide the user input.

The data repository (100) also stores an image template (106). The image template (106) is a data structure which defines one or more images or one or more layouts for images. The image template (106) is expressed, at least partially, in a computer-readable language (e.g., a .jpg format, .png format, or perhaps a proprietary image file format). However, the image template (106) also may include text, instructions for formatting text and images, etc.

The image template (106) thus includes a computer renderable data structure (108). The computer renderable data structure (108) is a specific type of data structure which may be rendered, by rendering software (e.g., a renderer), into one or more images or one or more images together with one or more instances of text.

In an embodiment, the image template (106) may include a message template inserted into an electronic message. For example, the image template (106) may be text, images, or a combination thereof, formatted for insertion into an electronic message (e.g., an email, a text, a short message service (SMS) message, etc.). In this case, the message template may include the image.

The data repository (100) also stores a prompt template (110). The prompt template (110) is a default prompt for a language model (e.g., the language model (124) defined below). The prompt template (110) also may include user-definable parameters for additional, user-related specific information into a particular prompt to be executed with the language model (124). The user-definable parameters are defined at the time of retrieval (or generation) and use of the prompt template (110).

The prompt template (110) is specific to a particular step in the computer-automated workflow (102). Thus, the data repository (100) may store many different instances of the prompt template (110).

The prompt template (110) is expressed as a prompt data structure (112). The prompt data structure (112) is natural language text stored in a computer-readable format. In the case of a multi-modal prompt, the prompt data structure (112) may contain, or may define a location for storing, an image. A multi-modal prompt is a prompt that contains both text and at least one image.

In an embodiment, the prompt template includes an instruction requiring the output to be expressed as a structured language data structure. For example, the prompt may command the language model to generate, as part of the output, a structured language data structure and to input the substance of the output into the structured language data structure. As a specific example, the prompt template may include an instruction requiring the output to be expressed as a JAVASCRIPT® (by Oracle America, Inc.) object notation (JSON) data structure, though other structured language data structures exist such as a comma separate value (CSV) data structure, a table, etc.

The data repository (100) also stores a combined prompt (114). The combined prompt (114) is a prompt executable with the language model (124). The combined prompt (114) is a combination of the image template (106) and the prompt template (110). Generation and use of the combined prompt (114) is described with respect to FIG. 2 and FIG. 3. In an embodiment, the combined prompt (114) is a multi-modal prompt.

The data repository (100) also stores an output (116). The output (116) is an output of the language model (124) when the language model (124) is executed on the combined prompt (114). Thus, the output (116) is computer-readable data that encodes text, one or more images, or a combination of text and one or more images. Generation and use of the output (116) is described with respect to FIG. 2 and FIG. 3.

The data repository (100) also stores a rendered data structure (118). The rendered data structure (118) is a rendered version of the output (116). As used herein, “rendered” potentially refers to more than an image data structure which a computer may display on a display device, though the rendered data structure (118) may be a rendered image that is displayable on a display device. More generally, the rendered data structure (118) is a data structure that is in a computer-readable data format useable by some other process of a computer. For example, the rendered data structure (118) may be expressed in a proprietary data format usable by a proprietary program, such as a word processing document, a portable document file (PDF), a computer assisted drawing (CAD) file, tax software, email software, etc. Nevertheless, the rendered data structure (118) remains a data structure in a computer-readable format for performing a useful function on a computer (e.g., for display on a display device or for execution by some other software).

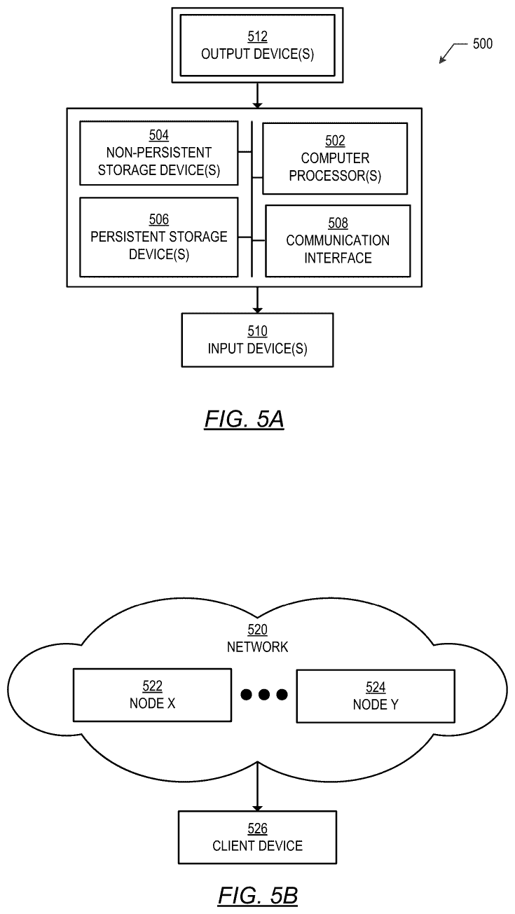

The system shown in FIG. 1A may include other components. For example, the system shown in FIG. 1A also may include a server (120). The server (120) is one or more computer processors, data repositories, communication devices, and supporting hardware and software. The server (120) may be in a distributed computing environment. The server (120) is configured to execute one or more applications, such as the language model (124), the server controller (126), or the communication interface (128). An example of a computer system and network that may form the server (120) is described with respect to FIG. 5A and FIG. 5B.

The server (120) includes a computer processor (122). The computer processor (122) is one or more hardware or virtual processors which may execute computer-readable program code that defines one or more applications, such as the language model (124), the server controller (126), or the communication interface (128). An example of the computer processor (122) is described with respect to the computer processor(s) (502) of FIG. 5A.

The server (120) also includes a language model (124). The language model (124) is a language processing machine learning model. An example of the language model (124) may be a large language model, such as CHATGPT® by OpenAI OpCo, LLC. However, many different language models may be used. Use of the language model (124) is described with respect to FIG. 2.

The server (120) also may include a server controller (126). The server controller (126) is software or application specific hardware which, when executed by the computer processor (120), controls and coordinates operation of the software or application specific hardware described herein. Thus, the server controller (126) may control and coordinate execution of the language model (124), the server controller (126), or the communication interface (128).

The server (120) also may include a communication interface (128). The communication interface (128) is hardware or software which permits communication between the server (120) and the user devices (130), or in another embodiment, between the server (120) and the end user devices (136). Details of the communication interface (128) are described with respect to the communication interface (508) described with respect to FIG. 5A.

The system shown in FIG. 1A also may include one or more user devices (130). The user devices (130) are computing devices used by a “user,” as opposed to an “end user,” as defined above. Thus, the user devices (130) are computers with which users may interact with the computer-automated workflow (102), defined above.

The user devices (130) may be considered remote or local. A remote user device is a device operated by a third-party (e.g., an end user of a chatbot) that does not control or operate the system of FIG. 1A. Similarly, the organization that controls the other elements of the system of FIG. 1A may not control or operate the remote user device. Thus, a remote user device may not be considered part of the system of FIG. 1A.

In contrast, a local user device is a device operated under the control of the organization that controls the other components of the system of FIG. 1A. Thus, a local user device may be considered part of the system of FIG. 1A.

In any case, the user devices (130) are computing systems (e.g., the computing system (500) shown in FIG. 5A) that communicate with the server (120). In another embodiment, one or more of the user devices (130) may be operated by a computer technician that services the various components of the system shown in FIG. 1A.

The user devices (130) include one or more user input devices, such as user input device (132). The user input device (132) is a physical or software device by which a user may provide input to the user devices (130) (e.g., keyboards, mice, microphones, etc.)

The user devices (130) include one or more display devices, such as display device (134). The display device (134) is a physical device by which a user may receive information from the user devices (130) (e.g., monitors, televisions, speakers, haptic devices, etc.)

The user devices (130) may interact with one or more end user devices (136). Again, an “end user” is distinguished from a “user” in that the “user” interacts with the computer-automated workflow (102) (whether via the server (120) or, if the computer-automated workflow (102) is installed on one of the user devices (130), via the user device in question). In contrast, an “end user” is a user that interacts with one of the user devices (130) (e.g., an “end user” may be a customer of the “user”). It is possible that an “end user” also may be a “user” with respect to some other workflow.

The end user devices (136) also are computing systems, as described above with respect to the user devices (130). The end user devices (136) include one or more end user input devices, such as end user input device (138). The end user input device (138) is as described above with respect to the user input device (132). The end user input device (138) also include one or more end user display devices, such as the end user display device (140). The end user display device (140) is as described above with respect to the display device (134).

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart of a language model method for dynamic workflow automation, in accordance with one or more embodiments. The method of FIG. 2 may be implemented using the system of FIG. 1 and one or more of the steps may be performed on or received at one or more computer processors.

Step 200 includes advancing a computer-automated workflow a step. The computer-automated workflow may be advanced by a number of different techniques. In an embodiment, the computer-automated workflow is advanced automatically, such as after a prior step of the computer-automated workflow is completed or upon initiation of the computer-automated workflow by some other process. In another embodiment, the computer-automated workflow may be advanced in response to a user indicating satisfaction that the current step of the computer-automated workflow has been completed. In still another embodiment, receipt of a selection of one or more outputs from among multiple outputs at a prior step may cause the computer-automated workflow to be advanced a step. Other techniques for advancing the computer-automated workflow may be used.

Step 202 includes retrieving an image template including a computer renderable data structure for rendering an image. The image template is specific to the step of the computer-automated workflow.

Retrieving the image template may be performed using a number of techniques. For example, the image template may be retrieved from one or more pre-generated image templates stored in a data repository (e.g., the image template (106) stored in the data repository (100) of FIG. 1). The image template may be retrieved from local or remote storage. The image template may be generated at the time that the current step of the computer-automated workflow is being performed. In this case, “retrieving” the image template is considered performed when the image template is generated.

Step 204 includes retrieving a prompt template including a prompt data structure for input to a language model. The prompt template is specific to the step.

Retrieving the prompt template may be performed using a number of techniques. For example, the prompt template may be retrieved from one or more pre-generated prompt templates stored in a data repository (e.g., the prompt template (110) stored in the data repository (100) of FIG. 1). The prompt template may be retrieved from local or remote storage. The prompt template may be generated at the time that the current step of the computer-automated workflow is being performed. In this case, “retrieving” the prompt template is considered performed when the prompt template is generated.

Step 206 includes combining the image template and the prompt template to generate a combined prompt. The image template and the prompt template may be combined by merging the information in the two templates together into a single prompt referred to as the combined prompt. However, other techniques may be used. For example, the prompt template may contain, or have added, a reference to an image in the image template. In another embodiment, the image template may be converted by an image captioning model (e.g., a convolutional neural network) into a text caption. The text caption then may be added to the text already contained in the prompt template.

In an embodiment, the prompt template includes blank sections or blocks for which information is to be provided during the combining process. For example, images or captions for images (or a combination thereof) from the image template may be inserted into the relevant blocks of the prompt template.

Other information also may be added to the prompt template, along with the image template. For example, the combining step also may include receiving user information regarding a user of the computer-automated workflow. In this case, the user information may be added to the prompt when generating the combined prompt. A specific example of adding user information to the prompt is shown in FIG. 4A through FIG. 4C, which show information about a user's products being added to the prompt template. In this case, the user's information is added to the appropriate blocks or blank sections in the prompt template.

Likewise, the method may include receiving end user information regarding an end user of a user of the computer-automated workflow. In this case, the end user information is added to the prompt when generating the combined prompt. Adding end user information may be performed in a similar manner to adding the user information.

Still other information may be added. For example, past emails may be added to the prompt, the outputs of other processes may be added to the prompt. Thus, combining the image template and the prompt template at step 206 may include many different combinations of information, in addition to the image template and the prompt template.

Still other variations are possible. For examples, the prompt template may include static blocks (i.e., text, figures, or commands that do not vary at step 206) and dynamic blocks (i.e., text, figures, or commands that may vary or may be inserted at step 206). In another example, a prompt may be embedded in a message template.

In an embodiment, any template described above may enumerate possibilities or variations for rendering the blocks later at step 210. In an embodiment, a template may include commands for selecting and arranging static or dynamic blocks within a message template during step 206. Still other variations are possible.

Step 208 includes executing a language model with the combined prompt to generate an output of the language model. Executing the language model may be performed by causing a processor to execute the language model with the prompt. The prompt may provide the instructions to the language model on how to process information contained in the prompt. The language model then is executed by the processor and generates an output.

The language model may be a large language model, as indicated above. Thus, the large language model may be a neural network trained on billions or more parameters using billions or more instances of training data. Thus, execution of the large language model on the prompt may generate an output that is more likely to be accurate.

Step 210 includes rendering the output to generate a rendered data structure. As indicated above with respect to the definition of a rendered data structure (118) in FIG. 1, a “rendered data structure” may take several different formats. Thus, the specific definition of a rendered data structure for a particular embodiment will cause the process of rendering the output to be varied accordingly. Nevertheless, several examples are provided of rendering the output to generate a rendered data structure.

In an embodiment, rendering the data structure includes displaying, on a display device, the rendered data structure. Displaying further may include displaying the rendered data structure on a first area of the display device and displaying the workflow and the step on a second area of the display device (see, e.g., FIG. 4C). In this case, the rendered data structure may be transmitted to a client device for displaying the rendered data structure on a client display device.

In the above embodiment, rendering the output includes generating an image file which a computer may readily display (.jpg, .png, a proprietary image file format, etc.). Thus, rendering the output may include using a renderer (a software application) to transform data in the output into a format suitable for a processor to display on a display device.

In another embodiment, rendering the output includes inserting the output into an electronic message. For example, the output may include text, one or more images, or a combination thereof that may be inserted into an electronic message. The electronic message then may be transmitted, for example, to an end user.

In still another embodiment, rendering the output includes formatting the output into a structured language data structure for use by a website or web browser. In yet another embodiment, rendering the output includes converting the output of the language model (which may be text, an image, a combination thereof, or a structured language data structure) into some other type of data structure. For example, rendering the output may include converting the output of the language model into a data structure readable by a proprietary program or some other program (e.g., a word processor, image manipulation software, CAD software, etc.). Other examples of rendering the output are possible.

The method of FIG. 2 may be varied, such as by adding, modifying, or removing steps. For example, the method of FIG. 2 also may include repeating the method when a user or automated process is not satisfied with the rendered data structure at step 210. In this case, the method also may include receiving a user command to reiterate the step. Then the method includes modifying, based on the user command, at least one of retrieving the prompt template and combining the image template and the prompt template to generate a modified combined prompt. Modifying then further includes at least one of retrieving a different prompt template and modifying the prompt template. In this case, the language model is executed on the modified combined prompt to generate a modified output. Finally, rendering includes rendering the modified output to generate an updated rendered data structure.

Similarly, multiple rendered data structures may be generated concurrently. Thus, for example, the method also may include retrieving an additional image template. The method then also includes combining the additional image template with the prompt template to generate an alternative prompt. The language model is then executed with the alternative prompt to generate an alternative output of the language model. The alternative output is rendered to generate an alternative rendered data structure.

In this case, the rendered data structure and the alternative rendered data structure may be displayed on a user device. A user selection of one of the rendered data structure and the alternative rendered data structure may be received. An electronic message may then be generated using the user selection. For example, the user selection may be used as the selected image for insertion into an image template used to generate the electronic message, or to insert the image directly into the electronic message.

In an embodiment, the electronic message may be transmitted to one or more third-party users, such as an end user. Alternatively, the electronic message may be stored or presented for selection by a user from among multiple such electronic messages.

In still another embodiment, the method may include combining a first rendered data structure (created by the method of FIG. 2) and a second rendered data structure (created by iterating the method of FIG. 2) into a combined rendered data structure. The combined rendered data structure may be inserted into an electronic message. The electronic message then may be transmitted, such as to an end user or some other entity, or may be stored for further processing.

In still another variation of the method of FIG. 2, the method may be part of a larger workflow process. Thus, for example, the method also may include receiving user acceptance of the rendered data structure. Then, responsive to receiving the user acceptance, the computer-automated workflow is advanced to a second step. A second image template, including a second computer renderable data structure for rendering a second image, is retrieved. The second image template is specific to the second step. A second prompt template, including a second prompt data structure for input to the language model, is retrieved. The second prompt template is specific to the second step. The second image template and the second prompt template are combined to generate a second combined prompt. The language model is executed with the second combined prompt to generate a second output of the language model. The second output is rendered to generate a second rendered data structure. The second rendered data structure may then be processed as described above with respect to step 210.

In an embodiment, the first and second rendered data structures may be displayed to a user for selection, the user selection inserted into an electronic message, and then transmitted. In another embodiment, the first and second rendered data structures may be combined and then presented to a user as a single option for inclusion in an electronic message, or for use in some other software system. Still other variations are possible.

While the various steps in this flowchart are presented and described sequentially, at least some of the steps may be executed in different orders, may be combined or omitted, and at least some of the steps may be executed in parallel. Furthermore, the steps may be performed actively or passively.

FIG. 3 shows a data flow for a language model method for dynamic workflow automation, in accordance with one or more embodiments. The data flow shown in FIG. 3 may be considered a variation of the method of FIG. 2, in which the components that perform the steps are shown.

Initially, a command (300) is received. The command (300) is a command to advance the workflow a step (e.g., to begin the workflow, to begin a next step in the workflow, etc.) The workflow (302) receives the command (300) and then advances to a workflow step (304), which is the current step of the workflow (302).

The workflow step (304) is provided to a server controller (306), which then determines what further steps, if any, are to be performed. In the embodiment of FIG. 3, the server controller (306) accesses a prompt template repository (308) to retrieve a prompt template (310). The prompt template (310) is specific to the workflow step (304). Thus, the prompt template (310) contains instructions to a language model (312) to perform actions that are specific to the workflow step (304).

The prompt template (310), in an embodiment, may be further modified before being provided to a language model (312) for execution. For example, user information regarding the user of the workflow may be added to the prompt template (310). Other information, such as end user information may be added to the prompt template (310). Still other information, such as publicly available information, available proprietary information, or other information may be added to the prompt template (310).

The prompt template (310) is provided to a language model (312) as input. The language model (312) is then commanded to execute with the prompt template (310). The output of the language model (312) is a structured language output (314), as described with respect to step 208 of FIG. 2. The structured language output (314) is provided as input to a server controller (316). The server controller (316) may be the same server controller as the server controller (306), or may be a different application instance.

Returning back to the server controller (306), the server controller (306) may also access an image template repository (318). The server controller (306) may retrieve an image template (320) from the image template repository (318). The image template (320) is specific to the workflow step (304). The image template (320) is also provided to the server controller (316).

The server controller (316) then combines the structured language output (314) (from the output of the language model (312)) and the image template (320) (from the image template repository (318)), and outputs a combined data structure (322). The combined data structure (322) is described with respect to FIG. 1 and FIG. 2.

The combined data structure (322) is then provided to a renderer (324). The renderer (324) is a software application or hardware programmed to convert the combined data structure (322) into a rendered data structure (326). Thus, for example, the renderer (324) may convert the combined data structure (322) into a rendered data structure (326) that may be displayed on a user device (328).

Next, a repeat decision (330) is made whether to repeat the process. If “yes,” then the data flow returns to workflow step (304). In an embodiment, the user device (328) may have rejected the rendered data structure (326). In this case, the same process described above is repeated, but at least one of the prompt template (310) and the image template (320) is changed or is modified. For example, some other information may be added to the prompt template (310), or information may be added to the image template (320), a different prompt template may be selected, a different image template may be selected, or a combination thereof. Thus, the ultimate rendered data structure (326) is different and is presented to the user device (328).

However, in another embodiment, a “yes” decision at the repeat decision (330) is a decision to advance the workflow (302). For example, the user may have indicated acceptance of the rendered data structure (326), and is ready to advance to a next workflow step. Thus, in this case, the workflow step (304) is a next step in the workflow (302). The process then repeats, but again the retrieved prompt template (310) and image template (320) are specific to the new workflow step.

Returning to the repeat decision (330), the repeat decision may be a “no.” For example, the user may wish to terminate the process. In another example, the workflow (302) may be completed. In still another example, the user input aspects of the workflow (302) may be completed. In any case, the workflow terminates thereafter.

FIG. 4A, FIG. 4B, and FIG. 4C show an example of a language model method for dynamic workflow automation, in accordance with one or more embodiments. In the example shown, the workflow is a computer-executed program that helps a user design and step through an email marketing program. Note that one or more embodiments are not limited to such workflows, and that the focus of the example of FIG. 4A through FIG. 4C is not in the workflow itself or on email marketing. Instead, the example focuses on demonstrating a practical application of the method of FIG. 2 and the workflow of FIG. 3, and how the user will perceive the end result of such a method, or workflow, from the user's perspective. FIG. 4A through FIG. 4C use similar reference numerals to refer to similar objects having similar descriptions.

FIG. 4A shows a workflow (400), which takes the form of a series of steps as shown. The workflow (400), as shown in the graphical user interface element (i.e., GUI element (402)), may be referred to as a “journey” from the user's perspective. The workflow (400) includes seven elements at which user input is to be received, as indicated by the boxes surrounded by two lines. However, the process of providing user input at one or more of the user input steps rely on complex user commands or complex user interfaces.

FIG. 4B shows a workflow portion (404) of the workflow (400) also shown in FIG. 4A. In particular, as shown in second GUI element (406), the user has selected the “next” widget and advanced the workflow (400) to a first step (408). The first step (408) is “send post-purchase thank you email.”

However, the process of generating the thank you email is complex. Namely, generating the email involves manipulating image files and text, as well as formatting the image files and text. The widgets, commands, and other software functions used to generate the email are, together, complex and difficult for an untrained user to use. The organization that generates and supports the workflow (400) generate revenue by the user of the workflow (400) paying for the service that generates the workflow (400). However, the user may be discouraged from using the workflow (400) if the user is frustrated by the process of manipulating the complex controls used in generating the thank you email.

Thus, the method of FIG. 2 or the workflow of FIG. 3 may be applied to automatically generate the thank you email for the user, and still ensure that the thank you email is specifically tailored to the user's specifications. In the example, when the workflow (400) advances to the first step (408), a server controller executes the method of FIG. 2 or the data flow of FIG. 3. A prompt template and an image template are retrieved. Both templates are specific to the first step (408). The prompt template, together with user specific data or end user specific data, are provided to a language model. The language model outputs a structured language output. The structured language output and image template are combined into a combined data structure. User specific data or end user specific data are added to the combined data structure. The combined data structure is then rendered into a rendered data structure.

In the example of FIG. 4B, the rendered data structure is displayed as display (410). The display (410) shows an email that includes images and text professionally formatted using the rendered data structure.

In an embodiment, the workflow (400) (or the workflow portion (404)) are displayed in a first display area (412). The display (410) is displayed in a second display area (414). The first display area (412) and the second display area (414) may be placed side-by-side in order for the user to see the workflow step (i.e., the first step (408)) side-by-side with the corresponding sample email generated by one or more embodiments. However, the first display area (412) and the second display area (414) may be placed in other orientations, such as above and below, or some other arrangement.

FIG. 4C shows a second workflow portion (416) of the workflow (400) of FIG. 4A in the first display area (412). FIG. 4C also shows that the user has advanced the workflow (400) to a second step (418). A third GUI element (420) shows a the user the step the user is at as well as a “next” widget with which the user may advance the workflow (400) or go back to a prior step in the workflow (400).

As shown in the second display area (414), a new email is generated by the method described with respect to FIG. 2 or the data flow described with respect to FIG. 3. Again, a prompt template and an image template are retrieved and processed, as described above, but now a new prompt template and image template specific to the second step (418) are retrieved, possibly modified, and processed. A new combined data structure is generated and rendered. The new rendered data structure is rendered as display (420). As can be seen, the display (420) is substantially different than the display (410), the display (420) is generated specifically for the second step (418) in the workflow (400). In this manner, the user again need not rely on the complex widgets and controls that otherwise the user would use in order to generate the professionally formatted email shown in the display (420).

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores, or micro-cores, of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output device(s) (512) may be the same or different from the input device(s) (510). The input device(s) (510) and output device(s) (512) may be locally or remotely connected to the computer processor(s) (502). Many different types of computing systems exist, and the aforementioned input device(s) (510) and output device(s) (512) may take other forms. The output device(s) (512) may display data and messages that are transmitted and received by the computing system (500). The data and messages may include text, audio, video, etc., and include the data and messages described above in the other figures of the disclosure.

Software instructions in the form of computer-readable program code to perform embodiments may be stored, in whole or in part, temporarily or permanently, on a non-transitory computer-readable medium such as a solid state drive (SSD), compact disk (CD), digital video disk (DVD), storage device, a diskette, a tape, flash memory, physical memory, or any other computer-readable storage medium. Specifically, the software instructions may correspond to computer-readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to, or be a part of, a network. For example, as shown in FIG. 5B, the network (520) may include multiple nodes (e.g., node X (522) and node Y (524), as well as extant intervening nodes between node X (522) and node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526). The services may include receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
advancing a computer-automated workflow a step;
retrieving an image template comprising a computer renderable data structure for rendering an image, wherein the image template is specific to the step;
retrieving a prompt template comprising a prompt data structure for input to a language model, wherein the prompt template is specific to the step;
combining the image template and the prompt template to generate a combined prompt;
executing a language model with the combined prompt to generate an output of the language model; and
rendering the output to generate a rendered data structure.

2. The method of claim 1, further comprising:
displaying, on a display device, the rendered data structure.

3. The method of claim 2, wherein displaying further comprises displaying the rendered data structure on a first area of the display device and displaying the workflow and the step on a second area of the display device.

4. The method of claim 1, further comprising:
transmitting the rendered data structure to a client device for displaying the rendered data structure on a client display device.

5. The method of claim 1, further comprising:
receiving a user command to reiterate the step;
modifying, based on the user command, at least one of retrieving the prompt template and combining the image template and the prompt template to generate a modified combined prompt;
executing the language model on the modified combined prompt to generate a modified output; and
rendering the modified output to generate an updated rendered data structure.

6. The method of claim 5, wherein modifying further comprises at least one of retrieving a different prompt template and modifying the prompt template.

7. The method of claim 1, wherein combining the prompt template further comprises:
receiving user information regarding a user of the computer-automated workflow; and
adding the user information to the prompt when generating the combined prompt.

8. The method of claim 1, wherein combining the prompt template further comprises:
receiving end user information regarding an end user of a user of the computer-automated workflow; and
adding the end user information to the prompt when generating the combined prompt.

9. The method of claim 1, wherein the image template comprises a message template insertable into an electronic message, wherein the message template includes the image.

10. The method of claim 1, wherein the prompt template comprises an instruction requiring the output to be expressed as a structured language data structure.

11. The method of claim 1, further comprising:
retrieving an additional image template;
combining the additional image template with the prompt template to generate an alternative prompt;
executing the language model with the alternative prompt to generate an alternative output of the language model; and
rendering the alternative output to generate an alternative rendered data structure.

12. The method of claim 11, further comprising:
displaying the rendered data structure and the alternative rendered data structure on a user device;
receiving a user selection of one of the rendered data structure and the alternative rendered data structure; and
generating an electronic message using the user selection.

13. The method of claim 12, further comprising:
transmitting the electronic message to a third-party user.

14. The method of claim 1, further comprising:
receiving user acceptance of the rendered data structure;
advancing, responsive to receiving the user acceptance, the computer-automated workflow to a second step;
retrieving a second image template comprising a second computer renderable data structure for rendering a second image, wherein the second image template is specific to the second step;
retrieving a second prompt template comprising a second prompt data structure for input to the language model, wherein the second prompt template is specific to the second step;
combining the second image template and the second prompt template to generate a second combined prompt;
executing the language model with the second combined prompt to generate a second output of the language model; and
rendering the second output to generate a second rendered data structure.

15. The method of claim 1, further comprising:
combining the first rendered data structure and the second rendered data structure into a combined rendered data structure;
inserting the combined rendered data structure into an electronic message; and
transmitting the electronic message.

16. The method of claim 1, wherein the computer-automated workflow comprises a plurality of blocks of a message template for an electronic message, and wherein the step comprises one of the plurality of blocks.

17. A system comprising:
a computer processor;
a data repository in communication with the computer processor, wherein the data repository stores:
a computer-automated workflow comprising a plurality of steps including a step,
an image template comprising a computer renderable data structure for rendering an image, wherein the image template is specific to the step,
a prompt template comprising a prompt data structure for input to a language model, wherein the prompt template is specific to the step,
a combined prompt,
an output of the language model, and
a rendered data structure;
the language model executable by the compute processor with the combined prompt to generate the output;
a server controller which, when executed by the processor, performs a computer-implemented method comprising:
advancing the computer-automated workflow by the step,
retrieving the image template and the prompt template,
combining the image template and the prompt template,
executing the language model to generate the output, and
render the output to generate the rendered data structure.

18. The system of claim 17, further comprising:
a display device programmed to display the rendered data structure.

19. The system of claim 17, wherein the server controller is further configured to generate an electronic message from the rendered data structure, and wherein the system further comprises:
a communication interface configured to transmit the electronic message.

20. A method comprising:
advancing a computer-automated workflow a step;
retrieving an image template comprising a computer renderable data structure for rendering an image, wherein the image template is specific to the step;
retrieving a prompt template comprising a prompt data structure for input to a language model, wherein the prompt template is specific to the step;
combining the image template and the prompt template to generate a combined prompt;
executing a language model with the combined prompt to generate an output of the language model;
rendering the output to generate a rendered data structure;
displaying, on a display device, the rendered data structure;
retrieving an additional image template specific to the step;
combining the additional image template with the prompt template to generate an alternative prompt;
executing the language model with the alternative prompt to generate an alternative output of the language model;
rendering the alternative output to generate an alternative rendered data structure;
displaying, on a display device together with the rendered data structure, the alternative rendered data structure;
receiving a user selection of one of the rendered data structure and the alternative rendered data structure;
generating an electronic message using the user selection; and
transmitting the electronic message over a computer network.
